(19) United States
(12) Patent Application Publication
(10) Pub. No.: US 2023/0241552 A1
(43) Pub. Date: Aug. 3, 2023

(54) A METHOD AND ARRANGEMENT FOR MANAGING AND CONTROLLING NITROGEN EMISSION FROM A CYCLIC LIQUOR FLOW SYSTEM IN A PULP MILL

(71) Applicant: VALMET AB, Sundsvall (SE)

(72) Inventors: Martin WIMBY, Torsland (SE); Naveen CHENNA, Tampere (FI); Erik Olof WALLIN, Kullavik (SE); Mikko RAIKO, Tampere (FI); Jarmo MANSIKKASALO, Pirkkala (FI); Camilla KARLEMO, Tampere (FI)

(73) Assignee: VALMET AB, Sundsvall (SE)

(21) Appl. No.: 17/925,924

(22) PCT Filed: May 18, 2021
(86) PCT No.: PCT/SE2021/050468

§ 371 Date: Nov. 17, 2022

(30) Foreign Application Priority Data
May 27, 2020 (SE) 2050607-7

(51) Int. Cl. B01D 53/56; B01D 53/78; D21C 11/06; D21C 11/10

(52) U.S. Cl. CPC B01D 53/56; B01D 53/78; D21C 11/06; D21C 11/10; B01D 2251/104; B01D 2251/106; B01D 2251/304; B01D 2251/604; B01D 2258/0283

(57) ABSTRACT

A method for managing and controlling nitrogen emission from a cyclic liquor flow system in a pulp mill (1), the pulp mill (1) comprising a recovery system (20) for recovering heat and chemicals from a pulping process (30), the recovery system (20) comprising a recovery boiler (8) and a nitrogen oxide scrubber (15), the nitrogen oxide scrubber (15) being arranged to remove nitrogen oxide from flue gas (16) from the recovery boiler (8), the method comprising the steps of: —exposing flue gas (16) from the recovery oiler (8) to an oxidizing agent, thereby oxidising nitrogen oxide in the flue gas (16) to higher nitrogen oxides; —contacting the flue gas (16) with an alkaline aqueous scrubber liquid (17) in the nitrogen oxide scrubber (15), thereby absorbing the nitrogen oxides in the scrubber liquid (17) and producing a nitrogen containing scrubber liquid (17); —introducing all or a part of the nitrogen containing scrubber liquid (17) into the cyclic liquor flow system. An arrangement for managing and controlling nitrogen emission from a cyclic liquor flow system in a pulp mill (1) is also disclosed.

### TECHNICAL FIELD

Disclosed herein is a method and an arrangement for managing and controlling nitrogen emission from a cyclic liquor flow system in a pulp mill, the pulp mill comprising a recovery system for recovering heat and chemicals from a pulping process, the recovery system comprising a recovery boiler and a nitrogen oxide scrubber, the nitrogen oxide scrubber being arranged to remove nitrogen oxide from flue gas from the recovery boiler.

### BACKGROUND OF THE INVENTION

Nitrogen oxides, NOx, are one of the main groups of pollutants present in flue gases from combustion processes or the like. If NOx is released to the atmosphere, it may react with moisture and form nitric acid, which may lead to occurrence of acidic rain. Furthermore, NOx may react with volatile organic compounds in the atmosphere and form ozone. Increased ozone levels in the troposphere cause smog as well as adversary health effects in humans. For these reasons, most countries have regulations for permitted levels of NOx in flue or exhaust gases released from industrial processes.

The flue gas from a pulp or paper mill recovery boiler typically contains nitrogen oxides which are present in the fuel (black liquor) in the recovery boiler and which originate from the pulp raw material used in the pulping process in the pulp or paper mill.

In order to reduce the amount of NOx emitted from a recovery boiler, a nitrogen oxide scrubber arrangement is generally provided for removing NOx from the flue gas before letting out the flue gas as exhaust into the atmosphere. Such scrubber arrangements operate to oxidize nitrogen oxides and optional other contaminants present in the flue gas by contacting the flue gas with an oxidizing agent thereby forming oxidation products of nitrogen oxide which is present in the flue gas leaving the recovery boiler. For nitrogen oxides the reactions include the following, of which the reaction (1) is predominant:

NO+O₃→NO₂+O₂ (1)

NO₂+O₃→NO₃+O₂ (2)

NO₂+NO₂→N₂O₄ (3)

NO₂+NO₃→N₂O₅ (4)

The oxidizing agents that are being used to convert the nitrogen oxide to higher ranking oxides are oxygen based oxidizing agents such as hydrogen peroxide and ozone, as well as chlorine containing oxidizing agents.

U.S. Pat. No. 5,639,434 A1 discloses a conventional process for removing nitrogen oxides from the flue gases of a soda recovery boiler of a pulp mill. The flue gases are typically oxidized by chlorine dioxide and subsequently led to a flue gas scrubber where the flue gases are treated with a scrubbing solution containing a reduction agent obtained from the chemical circulation of the pulp mill. The oxidized reagent is constituted by sodium sulphate and sulphur which is removed from the flue gas scrubber and led back to the circulation of chemicals in the pulp mill. The remaining scrubber liquid containing chloride is removed through a waste line from the lower part of the flue gas scrubber.

The presence of chloride in the recovery cycle of a kraft pulp mill is undesirable as it is negative to the operation of the recovery boiler. Chlorides affect the melting properties of the ash in the boiler and cause ash particles to form deposits on tube surfaces in the upper part of the recovery boiler which may eventually result in plugging of flue gas passages from the recovery boiler.

It is also desirable to avoid chlorides in waste liquids from the pulp mill as chlorides are harmful to the environment and need to be removed before the waste liquid can be let out in streams or lakes in the vicinity of the pulp mill.

U.S. Pat. No. 6,146,604 A1 discloses a method of removing nitrogen oxides from flue gases of a cellulose pulp mill recovery boiler involving introduction of a peroxide solution into recovery boiler flue gases having a temperature of about 300-800° C. The treated flue gases from the recovery boiler are preferably transported to a wet scrubber where they are scrubbed with an alkaline solution. The scrubbing solution may then be transported to the biological effluent treatment plant of the pulp mill where the nitrate in the scrubbing solution is used as a nutrient.

A further method and an arrangement for treating a gas flow to reduce the amount of NOx emitted to the atmosphere are previously disclosed in EP3384974A1. In EP3384974A1, flue gases, such as flue gases from a recovery boiler in the pulp industry are allowed to react with ozone to form higher nitrogen oxides from nitrogen dioxide to nitrogen pentoxide. The higher nitrogen oxides are then transferred in to a liquid phase in a wet scrubber and removed from the process mainly as dilute acid of HNO₃.

Although the method in EP3384974A1 is extremely efficient in removing NOx from flue gas, there still remains a need for an efficient and environmentally safe disposal of the nitrate containing scrubber liquid from the nitrogen oxide scrubber.

An object of the present disclosure is to provide a method and an arrangement offering improved nitrogen emission control in a cyclic liquor flow system in a pulping process.

A further object of the present disclosure is to offer an improved method and arrangement for control and management of nitrogen containing liquor from a nitrogen oxide scrubber used in a pulping process.

### SUMMARY OF THE INVENTION

The present disclosure is based on the insight that better management of liquid nitrogen emissions from a nitrogen oxide scrubber, may be achieved at least in part by the features of claim 1. Variations of the disclosure are set out in the dependent claims and in the following description.

Disclosed herein is a method for managing and controlling nitrogen emission from a cyclic liquor flow system in a pulp mill, the pulp mill comprising a recovery system for recovering heat and chemicals from a pulping process. The recovery system comprises a recovery boiler and a nitrogen oxide scrubber. The nitrogen oxide scrubber is arranged to remove nitrogen oxide from flue gas from the recovery boiler. The method comprises the steps of:
exposing the flue gas from the recovery boiler to an oxidizing agent, thereby oxidising nitrogen oxide in the flue gas to higher nitrogen oxides;
contacting the flue gas with an alkaline aqueous scrubber liquid in the nitrogen oxide scrubber, thereby absorbing the nitrogen oxides in the scrubber liquid;
introducing all or a part of the nitrogen containing scrubber liquid into the cyclic liquor flow system.

The term “cyclic liquor flow system” as used herein, refers to a liquor flow system comprising a main liquor cycle where at least a part of liquor which is used in the digester in a pulp mill is reconditioned and recycled to the digester. The cyclic liquor flow system may comprise sub-cycles of liquor flow from different process equipment in the pulp mill. It is also to be understood that liquor may be added and/or withdrawn from the cyclic liquor flow system.

When contacting the flue gas with the alkaline aqueous scrubber liquid the oxidation products in the flue gas react with the alkaline aqueous scrubber liquid. For example, reactions involving nitrogen oxides with an aqueous scrubber liquid comprising NaOH include the following:

2NaOH+NO+NO₂→2NaNO₂+H₂O

2NaOH+₂NO₂→NaNO₂+NaNO₃+H₂O

The reaction products, i.e. nitrites and nitrates, are formed when nitrogen oxides come into contact with the alkaline aqueous scrubber liquid. These reaction products are highly soluble in aqueous liquids. Therefore, nitrogen oxides are easily transferred from the flue gas into a liquid phase by absorption. Formed nitrites may further react with the oxygen present in the gas phase and be converted to nitrates. The nitrogen absorbed in the scrubber liquid will mainly be in the form of nitrates.

At the same time, optional sulphur oxides in the gas flow react with the alkaline aqueous scrubber liquid and form mainly sodium sulphite, sodium bisulphite and sodium sulphate that are also transferred to the liquid phase. Further, possible fly ash, dust and/or other solid particles are absorbed by the liquid phase and partially dissolved into it.

The recovery boiler is part of a recovery system in the pulp mill. In the recovery boiler, black liquor from the pulping process is burnt to recover chemicals and thermal energy generated in the burning process.

In addition to a recovery boiler, a recovery system in a pulp mill generally comprises an evaporator or other means for concentrating black liquor from the pulping process before introducing the concentrated black liquor from the evaporator into the recovery boiler. A dissolving tank is also commonly provided for dissolution of smelt from the recovery boiler. The dissolved smelt leaves the dissolving tank as green liquor, which is recausticized and recycled as white liquor to the digester of the pulp mill. A part of the white liquor may also be used in processing of the pulp after the digester e.g. in oxygen delignification.

As disclosed herein, nitrogen containing scrubber liquid may be introduced in virtually any part of the cyclic liquor flow system in the pulp mill. The nitrogen containing scrubber liquid may be introduced in any process equipment of the cyclic liquor flow system such as in an evaporator arranged before the recovery boiler, in a dissolving tank, in a caustiziser, in a digester, in a wash process, etc. The nitrogen containing scrubber liquid may additionally or alternatively be introduced between any such process equipment.

It has been found to be advantageous if introduction of all or a part of the nitrogen containing scrubber liquid into the cyclic liquor flow system comprises or consists of adding nitrogen containing scrubber liquid in one or more parts of the recovery system.

The recovery system may comprise a dissolving tank for dissolution of smelt from the recovery boiler and the method as disclosed herein may comprise adding nitrogen containing scrubber liquid to the dissolving tank.

A particular advantage of adding the nitrogen containing scrubber liquid to a dissolving tank is that the scrubber liquid can reduce or replace water addition to the smelt such that unwanted dilution of the scrubber liquid is minimized.

As disclosed herein the recovery system may comprise an evaporator for concentrating black liquor from the pulping process before supplying the concentrated black liquor to the recovery boiler, and wherein nitrogen containing scrubber liquid may be added to the evaporator.

As disclosed herein, the nitrogen containing scrubber liquid may be added, for example, to a dissolving tank, to an evaporator, to a pulp digester, in a caustiziser, in weak black liquor returned from the pulp digester or from pulp washing/bleaching to the evaporator. As disclosed herein nitrogen containing scrubber liquid retrieved from the nitrogen oxide scrubber may be added in two or more locations in the cyclic liquor flow system in the pulp mill.

It is generally accepted that approximately 20% to 30% of nitrogen in the black liquor burned in the recovery boiler leaves the recovery boiler as NOx in the flue gas from the recovery boiler. A part of the nitrogen from the black liquor exits the system as nitrogen gas which is let out to the atmosphere with the exhaust from the nitrogen oxide scrubber. Nitrogen is also removed from the system in the form of ammonia derived from the green liquor exiting the dissolving tank.

When operating a pulp mill as disclosed herein, while using all or part of the nitrogen containing scrubber liquid obtained from a nitrogen oxide scrubber in the recovery system of the pulp mill as a part of the cyclic liquor flow system in the pulp mill, the nitrogen content in the recovery boiler and in the flue gas from the recovery boiler will be somewhat higher than in a conventional process. In order to compensate for the increased NOx content in the flue gas from the recovery boiler, a corresponding greater amount of oxidizing agent will be needed to oxidize the NOx in the flue gas.

It may be preferred that the oxidising agent which is used in the method as disclosed herein is an oxygen based oxidizing agent such as hydrogen peroxide or ozone. It may be beneficial to avoid chlorides in the liquid which is returned to the cyclic recovery system.

In the method as disclosed herein, the alkaline aqueous scrubber liquid may comprise sodium hydroxide.

The pulping process in the method as disclosed herein may be a Kraft pulping process.

Disclosed herein is further an arrangement for managing and controlling nitrogen emission from a cyclic liquor flow system in a pulp mill, the arrangement comprising a recovery system for recovering heat and chemicals from a pulping process, the recovery system comprising a recovery boiler and a nitrogen oxide scrubber, the nitrogen oxide scrubber being arranged to remove nitrogen oxide from flue gas from the recovery boiler by absorption of nitrogen oxides in the flue gas in an alkaline aqueous scrubber liquid in the nitrogen oxide scrubber, wherein the arrangement for managing and controlling nitrogen emission further comprises an arrangement for introducing nitrogen containing scrubber liquid from the nitrogen oxide scrubber into the cyclic liquor flow system.

The arrangement for managing and controlling nitrogen emission from a cyclic liquor flow system in a pulp mill may be used when carrying out the method for managing and controlling nitrogen emission from a cyclic liquor flow system in a pulp mill, as disclosed herein.

As set out herein, the NOx containing flue gas leaving the recovery boiler is led to a nitrogen oxide scrubber where it is subjected to oxidation and subsequent absorption of nitrogen oxides in an alkaline scrubber liquid.

The scrubber arrangement disclosed in EP3384974A1 is a non-limiting example of a nitrogen oxide scrubber which may be used when carrying out the method as disclosed herein. The nitrogen oxide scrubber according to EP3384974A1 relies on ozone as an oxidizing agent and comprises an ozone treatment section, where ozone is brought into contact with the flue gas from the recovery boiler and where nitrogen oxides and optionally other contaminants present in the flue gas are reacted into oxidation products. A wet scrubber is arranged in connection with and after the ozone treatment section. The wet scrubber comprises a first section which has means for contacting oxidation products in the flue gas flow with a first aqueous reagent and transferring them from the flue gas flow into a first liquid phase, which is at least partially removed from the first section, and a second section, to which the gas flow proceeds from the first section, and which has means for contacting a second aqueous reagent with the gas flow, whereby ozone in the gas flow is transferred into a second liquid phase.

In the ozone treatment section nitrogen oxides and optional other contaminants present in the gas flow are allowed to react with ozone and form oxidation products. For nitrogen oxides the reactions include the following, of which the reaction (1) is predominant:

NO+O₃→NO₂+O₂ (1)

NO₂+O₃→NO₃+O₂ (2)

NO₂+NO₂→N₂O₄ (3)

NO₂+NO₃→N₂O₅ (4)

The ozone to NOx molar ratio in the ozone treatment section may be in the range from 0.3 to 3, preferably from 0.5 to 2.5. Preferably an excess of ozone is used in the ozone treatment section to enable a complete or near complete oxidation of nitrogen oxides and possible other contaminants.

The ozone treatment section may be formed as a duct and it may comprise, for example, an array of nozzles or the like, with which the ozone is introduced to the gas flow flowing through the duct. Preferably ozone is introduced to the gas flow in a plurality of locations in the ozone treatment section. The array of nozzles is arranged in the ozone treatment section in a manner that guarantees an effective mixing of the injected ozone with the gas flow, and thus the effective interaction between the ozone, nitrogen oxides and optional other contaminants. The array of nozzles may be a grid of pipes which are provided with nozzles, or an injection baffle.

It is possible to contact the gas flow from the ozone treatment zone with water or alkaline aqueous scrubber liquid or their mixture before the entry of the gas flow to the wet scrubber. This increases the moisture content of the gas flow and brings the gas close to or to its dew point before the entry into the wet scrubber, which improves the scrubbing results as well as heat recovery achieved in the wet scrubber.

The oxidation products in the gas flow are then reacted with an alkaline aqueous scrubber liquid to absorb the nitrogen oxides from the gas flow into the scrubber liquid.

In EP3384974A1, the flue gas flow is subsequently transferred from the first nitrogen absorption section of the wet scrubber to a second section of the wet scrubber. At this stage the flue gas flow is preferably almost or essentially free from nitrogen dioxides and higher oxides, e.g. nitrogen pentoxide, as well as from sulphur oxides, but may still contain ozone.

In the second section of the wet scrubber, the gas flow is contacted with a second aqueous reagent, which comprises at least one ozone depleter.

A part of the removed nitrogen containing liquid phase from the first section of the wet scrubber may be directed from the first section of the wet scrubber to the second section of the wet scrubber to form at least a part of the liquid used in the second section. This means that a part of the liquid phase from the first section may be used in the second section to deplete unreacted ozone. In this manner it is possible to effectively use the formed sulphite and possible transition metal cations as an active reagent in the process and to reduce the need for additional chemicals. This increases the cost efficiency of the emission control process and makes it more versatile. A small side-stream, such as 1-20 weight-%, 2-15 weight-%, or 5-10 weight-%, of the liquid phase from the first section of the wet scrubber may be directed to the second section of the wet scrubber.

If needed, the pH of the second aqueous scrubber liquid may be adjusted by feeding or mixing it with the aqueous scrubber liquid in the first section of the wet scrubber.

At least a part of the second aqueous scrubber liquid may be formed from an additional reagent flow, which is fed from a separate reagent reservoir. The second aqueous scrubber liquid may be formed of a mixture of the first liquid phase from the first section of the scrubber and the additional reagent flow from the separate reagent reservoir, or the second scrubber liquid may be obtained solely from the separate reagent reservoir. By supplying at least a part of the second aqueous scrubber liquid from the separate reagent reservoir, it is possible to guarantee that the concentration of ozone depleter is adequate for complete or near-complete depletion of ozone in the second section of the wet scrubber. Especially, if the concentration of anionic sulphur compounds in the liquid from the first section of the scrubber is low, sulphide, bisulphite and/or sulphite containing reagent flow may be fed from the separate reagent reservoir and form at least a part of the second aqueous scrubber liquid. This can be used especially in pulp mills where sulphite and sulphide chemicals are readily available.

The wet scrubber arrangement may thus comprise means for directing a part of the first scrubber liquid from the first section of the wet scrubber to the second section of the wet scrubber, where it forms at least a part of the second scrubber liquid. Alternatively, or in addition, the arrangement may comprise a separate reagent reservoir, which is connected to the means for contacting the second aqueous scrubber liquid with the gas flow.

The wet scrubber may comprise a heat exchanger, with which the heat energy of the gas flow may be recovered. This provides an overall improvement in the energy balance of the process. In an arrangement as set out in EP3384974A1 the heat exchanger may be arranged in the second section of the wet scrubber.

The arrangement in EP3384974A1 may also comprise a dry scrubber arranged before the ozone treatment section for treating the gas flow by removing sulphur compounds. If the gas flow comprises a significant amount of sulphur dioxide, it may be preferable to remove at least a part of the sulphur dioxide before the ozone treatment section. Otherwise ozone may be consumed by sulphur dioxide, which increases the amount of ozone needed for the emission control. Furthermore, when ozone reacts with sulphur dioxide, the reaction product is sulphur trioxide which can react further into sulphuric acid aerosol droplets. These aerosol droplets are hard to capture effectively in the wet scrubber and may thus be transported with the cleaned gas flow to the environment. The dry scrubber may also remove possible gaseous mercury. In general, installation of a dry scrubber before the ozone treatment zone provides yet enhanced emission control possibilities.

### BRIEF DESCRIPTION OF THE DRAWINGS

The methods and arrangements as disclosed herein will be further explained hereinafter with reference to the appended drawings wherein:

FIG. 1 shows a schematic representation of a pulp mill with a recovery system.

### DETAILED DESCRIPTION

Different aspects of the present disclosure will be described more fully hereinafter with reference to the drawings. The method and the arrangement disclosed herein should not be construed as being limited to the aspects set forth herein but can be varied within the scope of the appended claims.

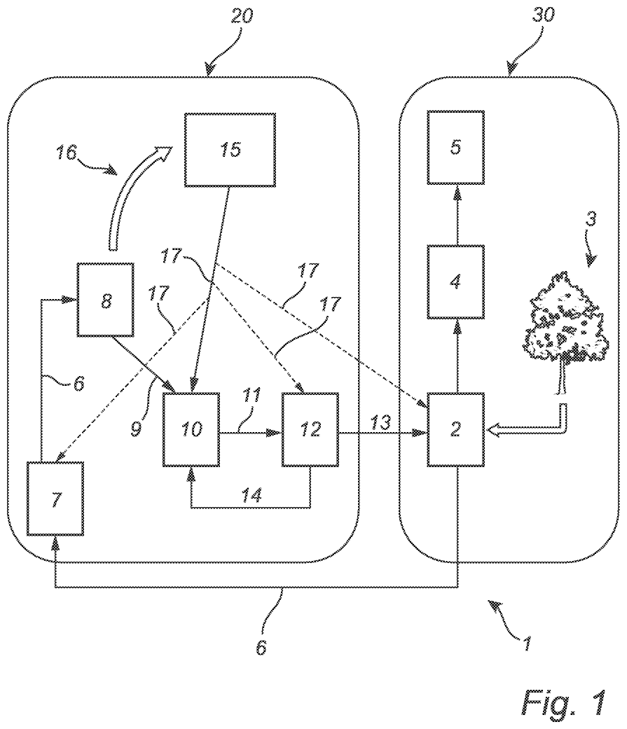

The pulp mill 1 which is shown in FIG. 1 in a highly schematic and simplified way is a Kraft pulp mill. Hence, it is to be understood that further equipment and process steps may be included in the pulping process and the recovery system of the pulp mill 1. The liquor flows which are shown in FIG. 1 are only the main liquor flows in the cyclic liquor flow system of the pulp mill 1. Further liquor flows may be part of the cyclic liquor flow system in the pulp mill 1. The pulp mill 1 comprises a digester 2 to which cellulosic raw material 3 such as wood chips is fed. In the digester 2, the cellulosic raw material is digested to free the cellulose fibres and to remove lignin, hemicelluloses and other extractives from the wood. The pulp produced in the digester 2, is washed in a washing arrangement 4 to obtain a refined and optionally bleached paper pulp 5. The cooking liquor from the digester 2, also referred to herein as black liquor 6, is a waste product of the Kraft process and is transferred from the digester 2 to an evaporator 7 where it is concentrated and subsequently introduced into a recovery boiler 8. Black liquor may also be transferred from the washing arrangement 4 to the evaporator 7. The concentrated black liquor 6 leaving the evaporator 7 is burned in the recovery boiler 8 to form a smelt 9 which is drawn off to a dissolving tank 10 where the smelt 9 is dissolved in weak white liquor to form green liquor 11. The green liquor is passed through a causticizer 12 and is clarified and filtered and eventually returned as white liquor 13 to the digester 2. Weak white liquor 14 from the wash process in the causticizer 12 is returned to the dissolving tank 10.

The pulp mill 1 further comprises a nitrogen oxide scrubber 15. Flue gas 16 from the recovery boiler 8 is first exposed to an oxidizing agent, such as ozone or hydrogen peroxide in order to oxidize NOx in the flue gas to higher nitrogen oxides. Thereafter the oxidized flue gas 16 is contacted with an alkaline aqueous scrubber liquid, such as a scrubber liquid containing sodium hydroxide, NaOH, in a wet section of the nitrogen oxide scrubber 15. The nitrogen oxides in the oxidized flue gas 16 from the recovery boiler 8 are absorbed in the alkaline scrubber liquid and the nitrogen containing scrubber liquid 17 is drawn off and fully or partly introduced into the cyclic liquor flow system of the pulp mill 1.

As can be seen from FIG. 1 the flow paths in the pulp mill 1 from the digester 2 to the evaporator 7, further to the recovery boiler 8 and the dissolution tank 10 and through the causticizer 12 back to the digester 2 make up the main flow paths of a cyclic liquor flow system in the pulp mill 1.

The evaporator 7, the recovery boiler 8, the dissolution tank 10, the nitrogen oxide scrubber 15 and the causticizer 12 are parts of a recovery system 20 of the pulp mill 1, the recovery system being arranged for recovery of heat and chemicals from the pulping process 30 which is carried out in the pulp mill 1.

As disclosed herein, the nitrogen containing scrubber liquid 17 which has absorbed nitrogen oxides, mainly in the form of nitrate NO₃⁻, may be introduced in virtually any part of the cyclic liquor flow system in the pulp mill 1.

It has been found to be particularly advantageous to introduce all or a part of the nitrogen containing scrubber liquid 17 to the dissolving tank 10 as indicated by the unbroken line from the nitrogen oxide scrubber 15 to the dissolving tank 10. Alternatively, or in addition to using the nitrogen containing scrubber liquid 17 in the dissolving tank 10, nitrogen containing scrubber liquid 17 may be supplied to one or more of the evaporator 7 the causticizer 12, the digester 2, etc. The nitrogen containing scrubber liquid 17 may be added directly to one or more of the above-mentioned appliances 2, 7, 10, 12 or may be added to a liquor flow into the appliance 2, 7, 10, 12. Wherever the nitrogen containing scrubber liquid 17 is added in the cyclic liquor flow system in the pulp mill 1, the nitrogen in the scrubber liquid 17 will again pass through the recovery boiler 8 and subsequently be partly removed from the system as ammonia from the dissolving tank 10 and as nitrogen gas from the nitrogen oxide scrubber 15 while approximately 25% of the nitrogen content in the black liquor 6 in the recovery boiler 8 will end up in the nitrogen containing scrubber liquid 17 from the nitrogen scrubber 15 and again be added to the cyclic liquor flow system in the pulp mill 1.

As disclosed herein, a particular advantage of adding the nitrogen containing scrubber liquid to a dissolving tank is that the scrubber liquid can reduce or replace water addition to the smelt from the recovery boiler such that unwanted dilution of the scrubber liquid is minimized.

1. A method for managing and controlling nitrogen emission from a cyclic liquor flow system in a pulp mill, the pulp mill comprising a recovery system for recovering heat and chemicals from a pulping process, the recovery system comprising a recovery boiler and a nitrogen oxide scrubber, the nitrogen oxide scrubber being arranged to remove nitrogen oxide from flue gas from the recovery boiler, the method comprising steps of:
exposing flue gas from the recovery boiler to an oxidizing agent, thereby oxidising nitrogen oxide in the flue gas to higher nitrogen oxides;
contacting the flue gas with an alkaline aqueous scrubber liquid in the nitrogen oxide scrubber, thereby absorbing nitrogen oxides in the scrubber liquid and producing a nitrogen containing scrubber liquid; and
introducing all or a part of the nitrogen containing scrubber liquid into the cyclic liquor flow system.

2. A method according to claim 1, wherein introduction of all or a part of the nitrogen containing scrubber liquid into the cyclic liquor flow system comprises or consists of adding nitrogen containing scrubber liquid in one or more parts of the recovery system.

3. A method according to claim 2, wherein the recovery system comprises a dissolving tank for dissolution of smelt from the recovery boiler and wherein nitrogen containing scrubber liquid is added to the dissolving tank.

4. A method according to claim 2, wherein the recovery system comprises an evaporator for concentrating black liquor from the pulping process before supplying the concentrated black liquor to the recovery boiler, and wherein nitrogen containing scrubber liquid is added to the evaporator.

5. A method according to claim 1, wherein nitrogen containing scrubber liquid is added to a digester in the pulping process.

6. A method according to claim 1, wherein the oxidising agent is an oxygen based oxidizing agent such as hydrogen peroxide or ozone.

7. A method according to claim 1, wherein the alkaline aqueous scrubber liquid comprises sodium hydroxide (NaOH).

8. A method according to claim 1, wherein the pulping process is a Kraft pulping process.

9. An arrangement for managing and controlling nitrogen emission from a cyclic liquor flow system in a pulp mill, the arrangement comprising:
a recovery system for recovering heat and chemicals from a pulping process, the recovery system comprising a recovery boiler and a nitrogen oxide scrubber, the nitrogen oxide scrubber being arranged to remove nitrogen oxides from flue gas from the recovery boiler by absorption of nitrogen oxides in the flue gas in an alkaline aqueous scrubber liquid in the nitrogen oxide scrubber, wherein the arrangement for managing and controlling nitrogen emission further comprises an arrangement for introducing nitrogen containing scrubber liquid from the nitrogen oxide scrubber into the cyclic liquor flow system.
